(19) United States
(12) Patent Application Publication
(10) Pub. No.: US 2011/0150359 A1
(43) Pub. Date: Jun. 23, 2011

(54) CURRENT LIMITATION METHOD OF DISPLAY DEVICE

(75) Inventors: Byoung Won HWANG, Gyunggi-do (KR); Kyung Ho LEE, Gyunggi-do (KR); Kyoung Soo KWON, Gyunggi-do (KR); Youn Joong LEE, Seoul (KR)

(73) Assignee: SAMSUNG ELECTRO-MECHANICS CO., LTD., Gyunggi-do (KR)

(21) Appl. No.: 12/761,444

(22) Filed: Apr. 16, 2010

(30) Foreign Application Priority Data
Dec. 23, 2009 (KR) 10-2009-0130052

(51) Int. Cl. G06K 9/40

(52) U.S. Cl. 382/274

(57) ABSTRACT

A current limitation method of a display device includes: calculating a brightness average in each frame of an inputted image; calculating a brightness difference between successive frames of the image by using the calculated brightness average, and calculating a cumulative average brightness value by cumulating the brightness average with respect to the frames included in a frame length which is varied depending on the brightness difference; converting the cumulative average brightness value into a preset brightness adjustment value; and adjusting the brightness of the inputted image according to the brightness adjustment value.

### CROSS-REFERENCE TO RELATED APPLICATIONS

This application claims the priority of Korean Patent Application No. 10-2009-0130052 filed on Dec. 23, 2009, in the Korean Intellectual Property Office, the disclosure of which is incorporated herein by reference.

### BACKGROUND OF THE INVENTION

1. Field of the Invention

The present invention relates to a current limitation method which is applicable to a display system, and more particularly, to a current limitation method of a display device, which calculates a cumulative brightness average while adaptively varying a length of a target frame, depending on an image brightness difference between successive frames, and adjusts image brightness by using the calculated cumulative brightness average.

2. Description of the Related Art

In a display system, research and development have been conducted on an automatic current limitation (ALC) algorithm which automatically reduces a current consumption by lowering screen brightness within an allowable range with respect to an unnecessarily bright screen, based on a brightness of an image signal.

A conventional current limitation method includes: calculating a brightness of an inputted image; calculating an image brightness average on a frame basis; calculating a cumulative average by cumulating an image brightness average on a basis of a predefined frame length; converting the cumulative average into a preset image brightness adjustment value; and adjusting the brightness of the inputted image according to the image brightness adjustment value.

However, in the process of calculating the cumulative average, the length of the target frame from which the cumulative brightness average will be calculated is fixed. Thus, when a scene is switched from a bright image to a dark image or from a dark image to a bright image in a moving picture, the calculating of the cumulative brightness average with respect to a plurality of frames corresponding to the fixed length is always performed even though it is unnecessary to make much reference to previous frames. Consequently, a response speed becomes slow and a current consumption characteristic is degraded. In serious cases, the slow response speed causes a flicker and image quality is thereby degraded.

### SUMMARY OF THE INVENTION

The present invention provides The present invention relates to a current limitation method of a display device, which is capable of increasing a response speed and improving a current characteristic by calculating a cumulative brightness average while adaptively varying a length of a target frame, depending on an image brightness difference between successive frames, and adjusting an image brightness by using the calculated cumulative brightness average.

According to an aspect of the present invention, there is provided a current limitation method of a display device, including: calculating a brightness average in each frame of an inputted image; calculating a brightness difference between successive frames of the image by using the calculated brightness average, and calculating a cumulative average brightness value by cumulating the brightness average with respect to the frames included in a frame length which is varied depending on the brightness difference; converting the cumulative average brightness value into a preset brightness adjustment value; and adjusting the brightness of the inputted image according to the brightness adjustment value.

The brightness cumulating operation may include: receiving brightness averages of the successive frames; calculating a brightness difference corresponding to a difference value between the brightness averages of the successive frames; determining a frame length which is varied depending on the brightness difference; and calculating a cumulative average brightness value by cumulating the brightness average with respect to the frames included in the determined frame length.

The brightness calculating operation may include: calculating a brightness of each pixel of the inputted image; and calculating a brightness average of each frame by using the calculated brightness of each pixel.

The brightness cumulating operation may include: receiving the brightness averages of the successive frames; calculating the brightness difference corresponding to the difference value between the brightness averages of the successive frames; determining the frame length which is varied depending on the brightness difference; and calculating the cumulative average brightness value by cumulating the brightness average with respect to the frames included in the determined frame length.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a current limitation method of a display device according to an embodiment of the present invention;

FIG. 2 is a detailed flowchart illustrating a brightness cumulating operation;

FIG. 3 is a graph showing the relationship between a brightness difference (DY) and a frame length according to an embodiment of the present invention;

FIG. 4 is a view explaining the number of frames included in a frame length according to an embodiment of the present invention; and

FIG. 5 is a table showing the relationship between a cumulative average brightness value (YAA) and a brightness adjustment value (OPT) according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and a description thereof will be omitted.

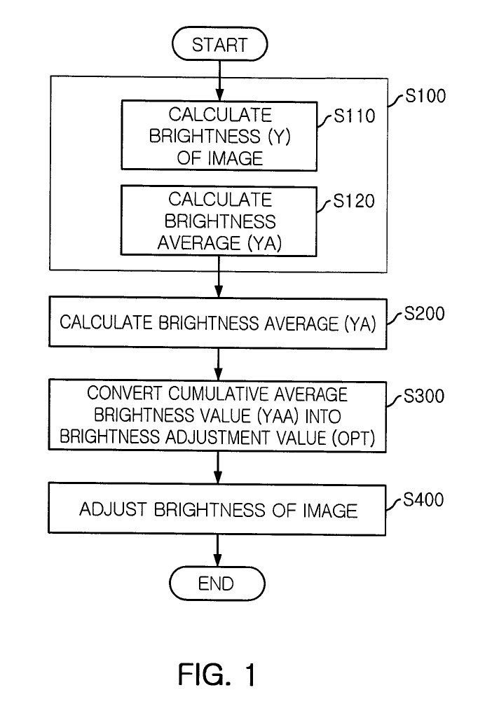

FIG. 1 is a flowchart illustrating a current limitation method of a display device according to an embodiment of the present invention.

Referring to FIG. 1, a current limitation method of a display device according to an embodiment of the present invention includes: calculating a brightness average (YA) in each frame of an inputted image (S100); calculating a brightness difference (DY(k)=YA(k)˜YA(k−1)) between two successive frames of the image by using the brightness average (YA) calculated in the brightness calculating operation S100, and calculating a cumulative average brightness value (YAA) by cumulating the brightness average with respect to the frames included in a frame length (L(k)) which is varied depending on the brightness difference (DY(k)) (S200); converting the cumulative average brightness value (YAA) calculated in the brightness cumulating operation S200 into a preset brightness adjustment value (OPT) (S300); and adjusting the brightness of the inputted image according to the brightness adjustment value (OPT) obtained in the converting operation S300 (S400).

The brightness calculating operation S100 may include a first operation S110 of calculating a brightness (Y) of each pixel in the inputted image, and a second operation S120 of calculating a brightness average (YA) in each frame by using the brightness (Y) of each pixel calculated in the first operation S110.

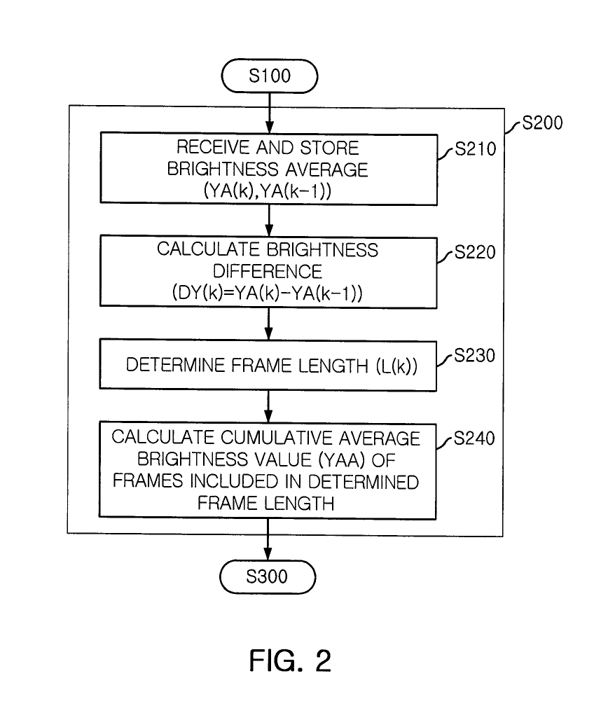

FIG. 2 is a detailed flowchart illustrating the brightness cumulating operation S200.

Referring to FIG. 2, the brightness cumulating operation S200 includes: receiving the brightness averages (YA(k), YA(k−1)) of the successive frames from the brightness calculating operation S100 (S210); calculating the brightness difference (DY(k)=YA(k)˜YA(k−1)) corresponding to the difference value between the brightness averages (YA(k), YA(k−1)) of the successive frames (S220); determining the frame length (L(k)) which is varied depending on the brightness difference (DY(k)) (S230); and calculating the cumulative average brightness value (YAA) by cumulating the brightness average (YA) with respect to the frames included in the determined frame length (L(k)) (S240).

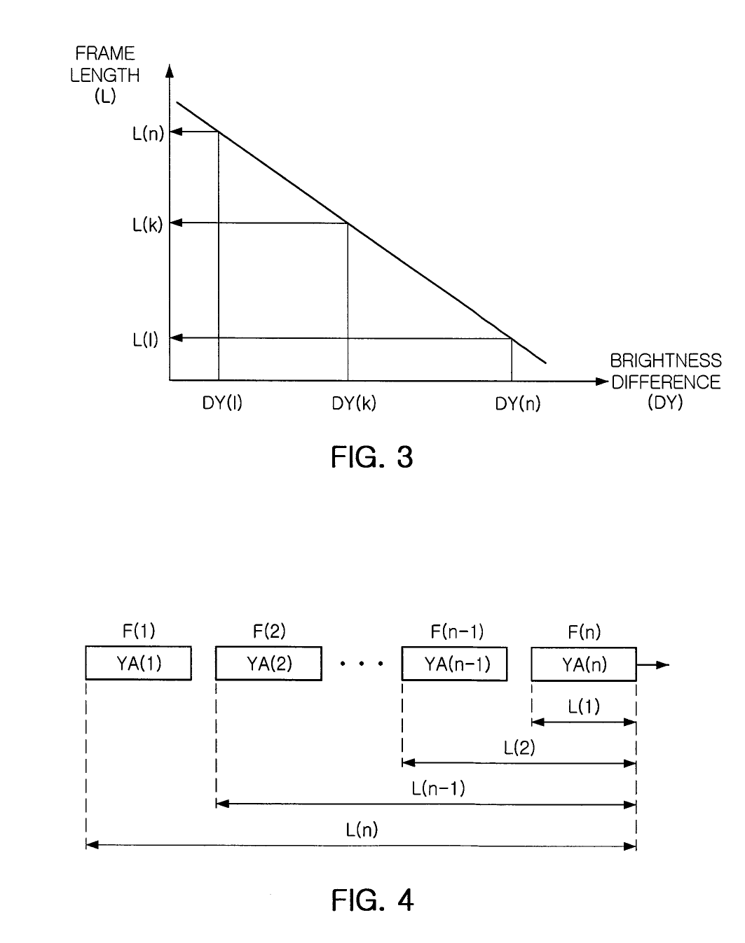

FIG. 3 is a graph showing the relationship between the brightness difference (DY) and the frame length according to an embodiment of the present invention. It can be seen from FIG. 3 that the brightness difference (DY) is in inverse proportion to the frame length (L). That is, when the brightness difference between the successive frames of the image is large, the frame length to be referred to may be set to be short because the brightness influence on the previous frame is low.

FIG. 4 is a view explaining the number of the frames included in the frame length according to an embodiment of the present invention. Specifically, FIG. 4 shows the number of the frames included in the frame length (L). As the frame length (L) is longer, the number of the frames included in the frame length (L) increases.

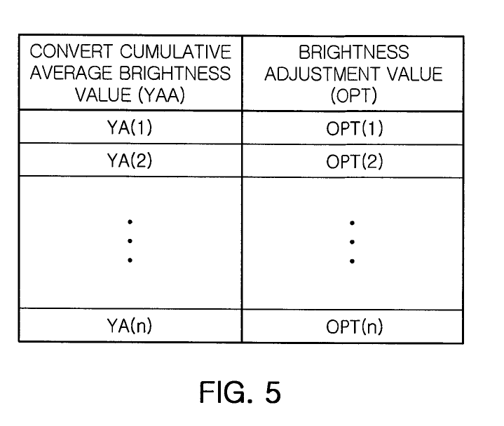

FIG. 5 is a table showing the relationship between the cumulative average brightness value (YAA) and the brightness adjustment value (OPT) according to an embodiment of the present invention. The brightness adjustment values (OPT) are previously matched with the brightness adjustment values (OPT). When the cumulative average brightness value (YAA) is determined, the corresponding brightness adjustment value (OPT) can be obtained.

Hereinafter, the operation and effect of the embodiment of the present invention will be described in detail with reference to the accompanying drawings.

The current limitation method of the display device according to the embodiment of the present invention will be described below with reference to FIGS. 1 to 5. Referring to FIG. 1, the brightness average (YA) in each frame of the inputted image is calculated in the brightness calculating operation S100, and the calculated brightness average (YA) is provided to the brightness cumulating operation S200.

More specifically, in the brightness calculating operation S100, the brightness (Y) in each pixel of the inputted image may be calculated in the first operation S110. In the second operation S120, the brightness average (YA) of each frame may be calculated using the brightness (Y) of each pixel which is calculated in the first operation S110.

In the brightness cumulating operation S200, the brightness difference (DY(k)=YA(k)˜YA(k−1)) between the successive frames of the image is calculated using the brightness average (YA) calculated in the brightness calculating operation S100, and the cumulative average brightness value (YAA) is calculated by cumulating the brightness averages with respect to the frames included in the frame length (L(k)) which is varied depending on the brightness difference (DY(k)), and the calculated cumulative average brightness value (YAA) is provided to the converting operation S300.

In the converting operation S300, the cumulative average brightness value (YAA) calculated in the brightness cumulating operation S200 is converted into the preset brightness adjustment value (OPT), and the preset brightness adjustment value (OPT) is provided to the brightness adjusting operation S400.

Referring to FIG. 5, the brightness adjustment values (OPT) are previously matched with the cumulative average brightness value (YAA). When the cumulative average brightness value (YAA) is determined, the corresponding brightness adjustment value (OPT) can be calculated.

In the brightness adjusting operation S400, the brightness of the inputted image is adjusted according to the brightness adjustment value (OPT) calculated in the converting operation S300.

The brightness cumulating operation S200 will be described below with reference to FIG. 2. In the receiving operation 5210, the brightness averages (YA(k), YA(k−1)) of the successive frames are received from the brightness calculating operation S100 and then stored.

In the brightness difference calculating operation S220, the brightness difference (DY(k)=YA(k)˜YA(k−1)) corresponding to the difference value of the brightness averages (YA(k), YA(k−1)) of the successive frames is calculated and provided to the operation S230.

It can be seen from FIG. 3 that the brightness difference (DY) is in proportion to the frame length (L). That is, when the brightness difference between the successive frames of the image is large, the frame length to be referred to may be set to be short because the brightness influence on the previous frame is low.

In the frame length determining operation S230, the frame length (L(k)) which is varied depending on the brightness difference (DY(k)) is determined, and the determined frame length (L) is provided to the cumulating operation 5240.

FIG. 4 shows the number of frames included in the frame length (L). It can be seen from FIG. 4 that as the frame length (L) is longer, the number of the frames included in the frame length (L) increases.

Referring to FIG. 4, the brightness average of the frame is calculated by adaptively varying the frame length (L) according to the image brightness difference (DY=Y(k)−Y(k−1)). In this case, the frame length (L) increases when the brightness difference (DY) is small, and decreases when the brightness difference (DY) is large.

The image switching is recognized using the difference of the image brightness. When the brightness difference of the image is large, the response speed is increased by reducing the frame length (L) for the cumulative average calculation. When the brightness difference of the image is small, the image brightness is controlled softly or smoothly by increasing the frame length (L).

As described above, unlike the conventional cumulative average calculating method using the fixed frame length, the cumulative brightness average is calculated by adaptively varying the length of the target frame according to the image brightness difference between the successive frames, and the brightness is adjusted using the calculated cumulative brightness average. Consequently, the response speed may be increased and the current characteristic may be improved. Furthermore, by calculating the cumulative average, it is possible to reduce the flicker which may occur during the image brightness adjustment.

While the present invention has been shown and described in connection with the exemplary embodiments, it will be apparent to those skilled in the art that modifications and variations can be made without departing from the spirit and scope of the invention as defined by the appended claims.

What is claimed is:

1. A current limitation method of a display device, comprising:
calculating a brightness average in each frame of an inputted image;
calculating a brightness difference between successive frames of the image by using the calculated brightness average, and calculating a cumulative average brightness value by cumulating the brightness average with respect to the frames included in a frame length which is varied depending on the brightness difference;
converting the cumulative average brightness value into a preset brightness adjustment value; and
adjusting the brightness of the inputted image according to the brightness adjustment value.

2. The current limitation method of claim 1, wherein the brightness cumulating operation comprises:
receiving brightness averages of the successive frames;
calculating a brightness difference corresponding to a difference value between the brightness averages of the successive frames;
determining a frame length which is varied depending on the brightness difference; and
calculating a cumulative average brightness value by cumulating the brightness average with respect to the frames included in the determined frame length.

3. The current limitation method of claim 1, wherein the brightness calculating operation comprises:
calculating a brightness of each pixel of the inputted image; and
calculating a brightness average of each frame by using the calculated brightness of each pixel.

4. The current limitation method of claim 3, wherein the brightness cumulating operation comprises:
receiving the brightness averages of the successive frames;
calculating the brightness difference corresponding to the difference value between the brightness averages of the successive frames;
determining the frame length which is varied depending on the brightness difference; and
calculating the cumulative average brightness value by cumulating the brightness average with respect to the frames included in the determined frame length.
